(19) United States
(12) Patent Application Publication
(10) Pub. No.: US 2019/0326816 A1
(43) Pub. Date: Oct. 24, 2019

(54) Apparatus for Power Converter with Efficient Switching and Associated Methods

(71) Applicant: Silicon Laboratories Inc., Austin, TX (US)

(72) Inventors: Jeffrey L. Sonntag, Austin, TX (US); Michael D. Mulligan, Austin, TX (US); Ion C. Tesu, Austin, TX (US)

(21) Appl. No.: 15/958,561

(22) Filed: Apr. 20, 2018

(51) Int. Cl. H02M 3/158

(52) U.S. Cl. CPC H02M 3/1582

(57) ABSTRACT

An apparatus includes a voltage converter to convert an input voltage to an output voltage. The voltage converter includes a first set of switches operated during a first switching phase. The voltage converter further includes a second set of switches operated during a second switching phase. The duration of the second switching phase is related to the duration of the first switching phase.

### TECHNICAL FIELD

The disclosure relates generally to electronic circuitry and, more particularly, to apparatus for power converters with improved performance characteristics, such as efficient switching, and associated methods.

### BACKGROUND

With advances in technology, an increasing number of circuit elements have been integrated into devices, such as integrated circuits (ICs). Furthermore, a growing number of devices, such as ICs, or subsystems, have been integrated into products. With developments such as the Internet of Things (IoT), this trend is expected to continue.

The growing number of circuit elements, devices, subsystems, etc., has also resulted in a corresponding increase in the amount of power consumed in the products that include such components. In some applications, such as battery powered, mobile, or portable products, a limited amount of power or energy is available. Given the relatively small amount of power or energy available in such applications, reduced power consumption of the components or products provides advantages or benefits, for example, extending the battery life, increasing the “up-time” or active time of the system, and the like. Even in non-portable environment, increased power consumption invariably results in larger amounts of generated heat, as the electrical energy is not used 100% efficiently. Thus, reduced power consumption of the components or products provides advantages or benefits, for example, reduced heat amounts, reduced cost of electricity, and the like.

Because of a mismatch between a typical supply or input voltage (e.g., battery voltage) and the desired supply voltage for loads, often voltage converters are used to supply power to loads. More specifically, one or more voltage converters are used to convert the input voltage to either a higher or a lower voltage that is suitable for supplying power to various loads.

The description in this section and any corresponding figure(s) are included as background information materials. The materials in this section should not be considered as an admission that such materials constitute prior art to the present patent application.

### SUMMARY

A variety of apparatus and associated methods are contemplated according to exemplary embodiments. According to one exemplary embodiment, an apparatus includes a voltage converter to convert an input voltage to an output voltage. The voltage converter includes a first set of switches operated during a first switching phase. The voltage converter further includes a second set of switches operated during a second switching phase. The duration of the second switching phase is related to the duration of the first switching phase.

According to another exemplary embodiment, an IC includes a buck-boost voltage converter to convert an input voltage to an output voltage. The buck-boost voltage converter includes an inductor coupled to a set of switches. The buck-boost voltage converter further includes a controller to control a first set of switches in the set of switches for a first period of time, and to control a second set of switches in the set of switches for a second period of time. The second period of time is related to the first period of time by a ratio.

According to another exemplary embodiment, a method of operating a voltage converter operating a first set of switches in the voltage converter for a first duration. The method further includes operating a second set of switches in the voltage converter for a second duration. The second duration is derived from the first duration in order to trade off an efficiency of the voltage converter with an output-voltage ripple of the voltage converter.

### BRIEF DESCRIPTION OF THE DRAWINGS

The appended drawings illustrate only exemplary embodiments and therefore should not be considered as limiting the scope of the application or the claims. Persons of ordinary skill in the art will appreciate that the disclosed concepts lend themselves to other equally effective embodiments. In the drawings, the same numeral designators used in more than one drawing denote the same, similar, or equivalent functionality, components, or blocks.

FIG. 1 shows a circuit arrangement that includes a buck-boost voltage converter according to an exemplary embodiment.

FIG. 2 shows waveforms associated with a conventional buck-boost voltage converter.

FIG. 3 shows waveforms associated with a buck-boost voltage converter according to an exemplary embodiment.

FIG. 4 shows a circuit arrangement for an IC that includes a voltage converter according to an exemplary embodiment.

FIG. 5 shows a circuit arrangement for an IC that includes a voltage converter according to another exemplary embodiment.

FIG. 6 shows a circuit arrangement for an IC that includes a voltage converter according to another exemplary embodiment.

FIG. 7 shows a circuit arrangement for an IC that includes a voltage converter according to another exemplary embodiment.

FIG. 8 shows a circuit arrangement for controlling switching phases in a voltage converter according to an exemplary embodiment.

FIG. 9 shows a circuit arrangement for controlling switching phases in a voltage converter according to another exemplary embodiment.

FIG. 10 shows waveforms associated with the operation of the circuit in FIG. 9.

FIG. 11 shows a circuit arrangement for controlling switching phases in a voltage converter according to another exemplary embodiment.

FIG. 12 shows waveforms associated with the operation of the circuit in FIG. 11.

FIG. 13 shows a circuit arrangement for controlling switching phases in a voltage converter according to another exemplary embodiment.

FIG. 14 shows waveforms associated with the operation of the circuit in FIG. 13.

FIG. 15 shows a circuit arrangement for an IC, including a voltage converter, according to an exemplary embodiment.

### DETAILED DESCRIPTION

The disclosed concepts relate generally to electronic circuitry and, more particularly, to apparatus for electronic power converters with improved performance characteristics such as more efficient switching, and associated methods. The power or voltage converters may be used in a variety of applications, such as in portable or mobile electronic equipment or in electronic equipment that receive power from a source such as a battery (or super-capacitor).

A variety of schemes have been used conventionally to control DC-DC converters (e.g., voltage converters that convert a DC input voltage from a battery to a suitable DC output voltage for a load, such as an IC). For example, in a widely used scheme, the duty-cycle of the waveforms controlling one or more switches in the converter is changed in response to changes such as the input voltage, the output current, etc.

In voltage converters according to various embodiments, as described below, a three-phase switching scheme is used where the duration of the second switching phase is related to the duration of the first switching phase, rather than an arbitrary duration. In such voltage converters, with three switching phases, the timing of the second tracks (or is related to or is derived from or depends on) the timing pulsewidth of the first switching phase.

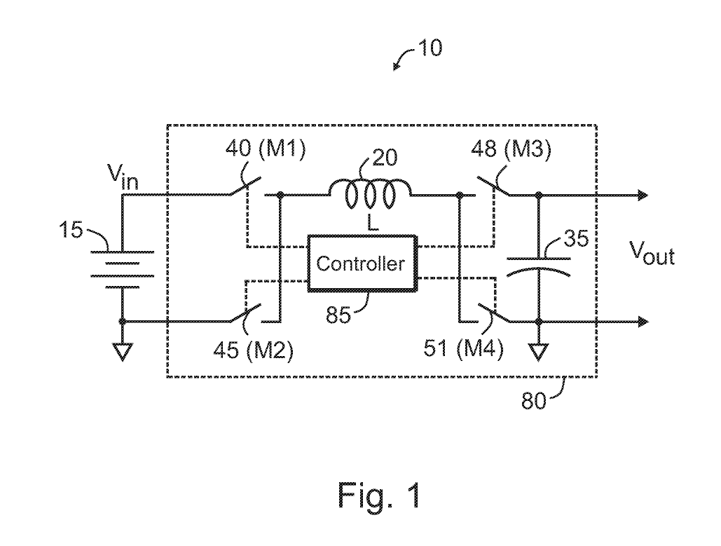

FIG. 1 shows a circuit arrangement 10 that includes a DC-DC switch-mode buck-boost voltage converter 80 according to an exemplary embodiment. Voltage converter 80 receives an input voltage Vᵢₙ from a source (such as the battery shown in this example). Voltage converter 80 converts the input voltage Vᵢₙ to an output voltage Vₒᵤₜ, which is typically provided to a load (not shown).

Voltage converter 80 can operate in either buck (step down) or boost (step up) modes of operation. In the buck mode of operation, voltage converter 80 converts the input voltage to an output voltage that has a lower voltage level than does the input voltage. Conversely, in the boost mode of operation, voltage converter 80 converts the input voltage to an output voltage that has a higher voltage level than the input voltage.

In the embodiment shown, voltage converter 80 includes inductor (L) 20, capacitor 35, switch 40, switch 45, switch 48, switch 51, and controller 85. Switches 40, 45, 48, and 51 open and close under the control of controller 85. In various embodiments, switches 40, 45, 48, and 51 constitute transistors. In some embodiments, switches 40, 45, 48, and 51 constitute MOSFETs. In some embodiments, switches 40, 45, 48, and 51 constitute BJTs or insulated-gate bipolar transistors (IGBTs). Other types of switch are contemplated and may be used, as persons of ordinary skill in the art will understand.

To control the switches, controller 85 provides current or voltage control signals (depending on the type of transistor used) to switches 40 (M1), 45 (M2), 48 (M3), and 51 (M4), similar to the boost converter described above. As described below in detail, controller 85 uses an additional switching phase to provide more efficient switching of switches 40, 45, 48, and 51 (or more efficient of the switching of the states of the switches, such as from on to off, or vice-versa). Capacitor 35 reduces the output ripple-voltage of the converter, and also provides some current to the load during transients (or during the relatively short period during which the states of switches 40, 45, 48, and 51 change).

Through the switching action of switches 40, 45, 48, and 51 inductor 20 is charged and discharged repetitively. The charge is delivered to a load (not shown, but coupled to the output node, i.e., the node labeled “Vₒᵤₜ”). In this process, capacitor 35 is charged. Capacitor 35 reduces the output ripple-voltage of the converter, and also provides some current to the load during transients (or during the period during which the states of the switches change or when all switches are in the off state).

In conventional buck-boost converters, switches 40, 45, 48, and 51 are switched as pairs. In other words, in one phase of operation of a conventional buck-boost converter, switches 40 (M1) and 51 (M4) are switched to the on state, whereas switches 45 (M2) and 48 (M3) are switched to the off state. Conversely, in a second phase of operation of a buck-boost converter, switches 40 (M1) and 51 (M4) are switched to the off state, whereas switches 45 (M2) and 48 (M3) are switched to the on state.

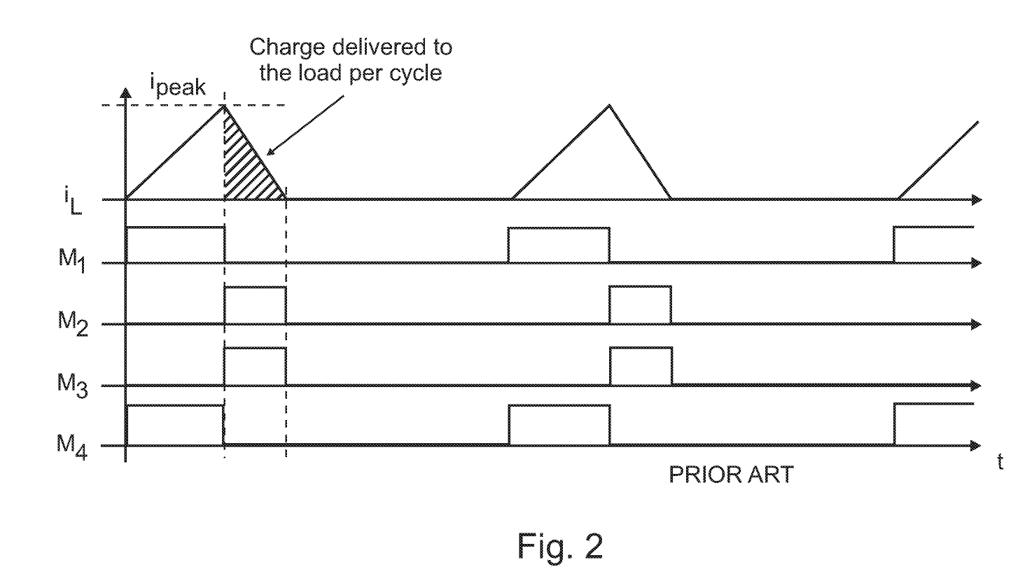

FIG. 2 shows waveforms associated with a conventional buck-boost voltage converter. The inductor current (i_{L}) shows that during each cycle the inductor is charged to a peak current, iₚₑₐₖ, and then subsequently is discharged to deliver charge to the load. The charge delivered to the load per cycle is depicted using a hashed area. Waveforms labeled M₁-M₄ depict the drive waveforms for the converter switches. Thus, as noted above, for a conventional converter, switches 40 (M1) and 51 (M4) are switched to the on state, whereas switches 45 (M2) and 48 (M3) are switched to the off state, and vice-versa.

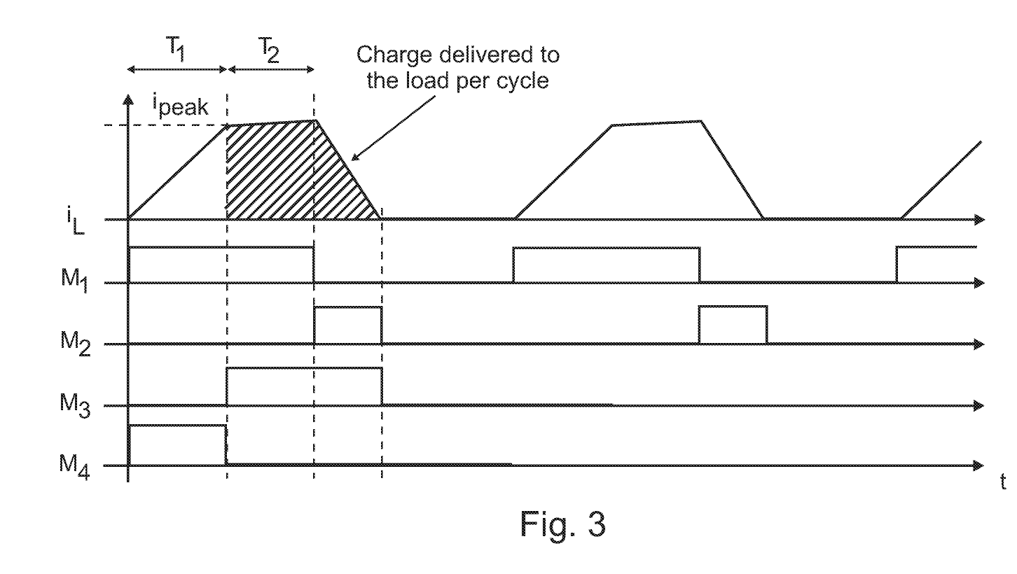

As described below, buck-boost voltage converters according to various embodiments use a different switching scheme for switches 40, 45, 48, and 51 than do conventional converters. More specifically, rather than changing the states of the switches by using switch pairs, allowing switch pairs 40 (M1) and 51 (M4), and 45 (M2) and 48 (M3) to switch independently, a second switching phase is added between the first phase (which charges the inductor) and the third switching phase (which discharges the inductor to deliver charge to the load). FIG. 3 shows the waveforms corresponding to such a switching scheme.

More specifically, FIG. 3 shows waveforms associated with a buck-boost voltage converter according to an exemplary embodiment that includes three switching phases. The reference to the switches correspond to the switch designations in FIG. 1.

Referring again to FIG. 3, the top-most waveform shows the current flowing through inductor 20. The remaining four waveforms show the control waveforms for switches 40 (M1), 45 (M2), 48 (M3), and 51 (M4). In various embodiments, the control waveforms may be voltage or current waveforms, depending on factors such as the type of switch used, as persons of ordinary skill in the art will understand.

Referring again to FIG. 3, during the first switching phase, denoted as the time period T₁, switches M1 and M4 are turned on. As a result, inductor 20 charges to a peak current denoted as iₚₑₐₖ. At the conclusion of the first switching phase, i.e., when the inductor current reaches iₚₑₐₖ, switch M4 is turned on, while switch M1 remains on. The second switching phase thus commences.

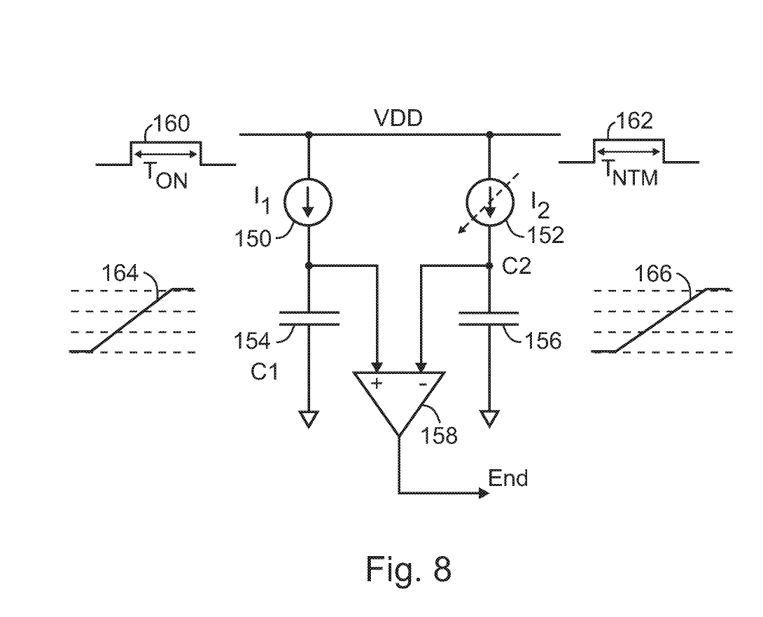

During the second switching phase, denoted as the time period T₂, switch M1 is on, as is switch M3. The timing of the second switching phase is related to the timing of the first switching phase. In other words, the duration of the second switching phase is related to the duration of the first switching phase. In some embodiments, the duration of the second switching phase is a fixed fraction (a number greater than zero and less than or equal to unity) of the duration of the first switching phase. In other words, the ratio of the respective durations of the second and first switching phases is constant. Note that in exemplary embodiments the ratio of the respective durations of the second and first switching phases may be less than, equal, or greater than unity (100%), as desired. The mechanism for changing the ratio depends on the circuitry used to implement controller 85. For example, in some embodiments, as described below in detail (see, e.g., FIGS. 8, 11, and 13), a pair of current sources or resistors are used to charge corresponding capacitors, and the ratio may be changed by changing the ratio of the output currents of the current sources or by changing the resistance values of the resistors, as persons of ordinary skill in the art will understand.

In other embodiments, the duration of the second switching phase is a variable fraction of the duration of the first switching phase. In other words, the ratio of the respective durations of the second and first switching phases is variable, e.g., in response to conditions in the converter, in the load, in the input voltage, in the output voltage, user commands (e.g., response to conditions or changes in the block, subsystem, or system in which the voltage converter resides or to which the voltage converter supplies power), etc., as persons of ordinary skill in the art will understand.

In some embodiments, the duration of the second switching phase is a variable fraction of the duration of the first switching phase, where the ratio is dynamically varied. For instance, in some situations, the ratio may be set to an initial value upon startup of voltage converter 80, but may later be changed in response to one or more changes, for instance, as described above. In response to further changes, the ratio may be changed again, in a dynamic manner.

The third switching phase follows the second switching phase. At the conclusion of the second switching phase, switch M1 turns off, while switch M3 remains on. Also, switch M2 turns on, and the third switching phase commences. During the third switching phase, the charge in the inductor is delivered to the load. At the conclusion of the third switching phase, the entire switching cycle (i.e., the first, second, and third switching phases) repeats, possibly after a period of time, depending on whether the voltage converter is operating in the continuous-conduction mode or in the discontinuous-conduction mode. Table 1 below summarizes the state of the switches of voltage converter 80 during the various switching phases:

TABLE 1

| | Switching Phases | | |
|---|---|---|---|
| Switch | Phase 1 | Phase 2 | Phase 3 |
| M1 | On | On | Off |
| M2 | Off | Off | On |
| M3 | Off | On | On |
| M4 | On | Off | Off |

Regardless of the mode of operation, as noted above, and as described below in more detail, the timing of the second switching phase is related to the timing of the first switching phase. The timing of the second switching phase affects various attributes of the voltage converter, such as the tradeoff between output-voltage ripple and the converter's efficiency (i.e., how efficiently the converter converts the input voltage to the output voltage).

Thus, in voltage converters according to various embodiments, an improved tradeoff between output-voltage ripple and converter efficiency may be obtained that tracks or responds to changes in system components or component characteristics, input-output voltage differentials or values, etc. The tradeoff allows more efficient switching of the voltage converter's switches compared to arbitrary timing of the second switching phase. The tradeoff is obtained by changing the timing of the second switching phase in relation to the timing of the first switching phase.

Setting the duration of the second switching phase (T₂) to a fixed, relatively short value may result in reduced output-voltage ripple, but doing so also lowers conversion efficiency (a shorter T₂ period results in more frequent repetition of the overall switching cycle, which results in more losses in the non-ideal, practical switches). Conversely, setting the duration of the second switching phase to a fixed, relatively large value may result in improved conversion efficiency, but at the expense of increased output-voltage ripple.

Generally speaking, the specification of the output-voltage ripple for a given application depends on various factors, such as the input voltage value in relation to the output voltage value, the type of load, the inductance of inductor 20, etc., as persons of ordinary skill in the art will understand. By having the duration of the second switching phase (T₂) track (or generally be related to or derived from) the duration of the first switching phase (T₁) provides a better general-purpose tradeoff between conversion efficiency and output-voltage ripple.

Moreover, the tracking between the durations of the respective switching phases allows the tradeoff to track various changes in system parameters, as noted above. In addition, in some embodiments, the ratio between the durations of the second and first switching phases may be variable, which allows an entity (e.g., a parameter in a system, the choice of a user of the voltage converter and/or system, etc.) to modify the tradeoff to suit one or more goals or desired outcomes.

DC-DC switch-mode converters according to various embodiments may be used in a variety of apparatus. Examples include systems, sub-systems, blocks, electronic circuits, ICs, multi-chip modules (MCMs), thin-film circuits, thick-film circuits, etc., as persons of ordinary skill in the art will understand.

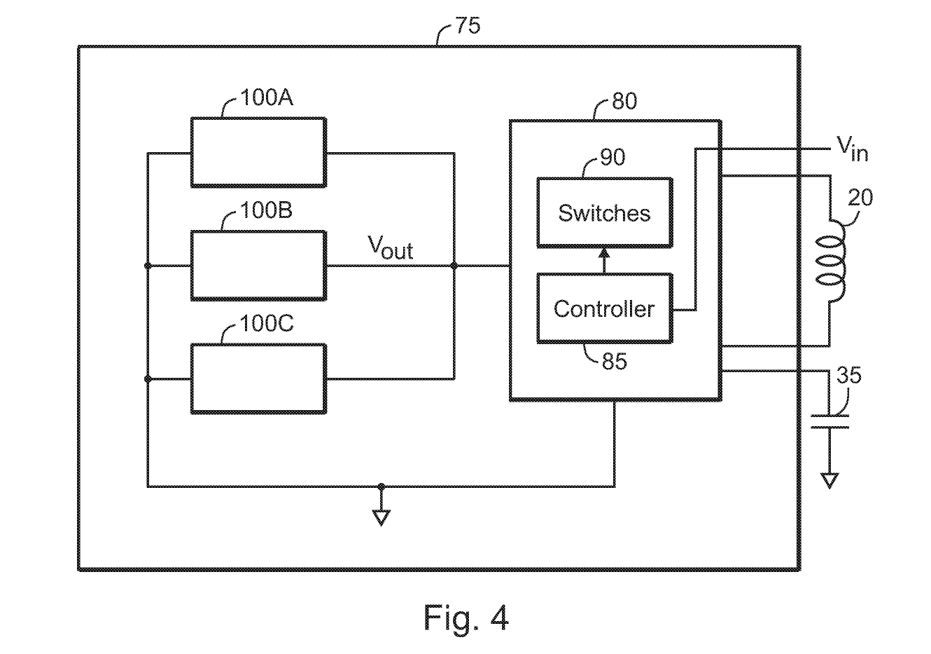

Without limitation, FIGS. 4-7 provide examples of DC-DC switch-mode converters used in ICs. FIG. 4 shows a circuit arrangement for an IC 75 that includes a voltage converter 80 according to an exemplary embodiment. In various embodiments, voltage converter 80 may constitute one of the voltage converters shown in FIGS. 2-3, described above. Referring again to FIG. 4, voltage converter 80 includes controller 85, which controls a set of switches 90. Switches 90 may include a number of switches, such as switches 25 and 30 (see FIG. 1) or switches 40, 45, 48, and 51 (see FIG. 3), depending on the choice of topology of voltage converter 80.

Referring again to FIG. 4, controller 85 controls switches 90 using the techniques described above. Thus, in exemplary embodiments, switches 90 are switched according to the switching scheme shown in Table 1 above.

In various embodiments, voltage converter 80 produces one or more output voltages. In the exemplary embodiment shown, voltage converter 80 produces output voltage Vₒᵤₜ. Output voltage Vₒᵤₜ is provided to one or more loads. In the exemplary embodiment shown, voltage converter 80 provides the output voltage Vₒᵤₜ to a set of three loads although, as persons of ordinary skill in the art will understand, different numbers of loads, such as a single load, two loads, or more than three loads may be used, as desired.

Referring again to FIG. 4, the set of loads includes load 100A, load 100B, and load 100C. In various embodiments, load 100A may constitute (or include) analog circuitry, load 100B may constitute digital circuitry, and load 100C may constitute mixed-signal circuitry. As persons of ordinary skill in the art will understand, however, different configurations and/or types of load may be used in various embodiments. For instance, in some embodiments, load 100A may be used, and loads 100B-100C may be absent. As another example, in some embodiments, load 100B may be used, while loads 100A and 100C may be absent. As another example, in some embodiments, load 100C may be used, and loads 100A-100B may be absent. As yet another example, in some embodiments, loads 100A and 100B may be used, while load 100C may be absent.

As described above, voltage converters according to various embodiments include at least one inductor (shown as inductor 20) and at least one capacitor (shown as capacitor 35, although capacitor 35 may be omitted if one or more loads include sufficient capacitance). A variety of configurations are contemplated and are possible for inductor 20 and capacitor 35.

In the embodiment shown, inductor 20 and capacitor 35 (if used) are external to IC 75. Thus, inductor 20 and capacitor 35 are coupled to voltage converter 80 using coupling mechanisms of IC 75, such as pads, bondwires, ball grid array, etc., as persons of ordinary skill in the art will understand.

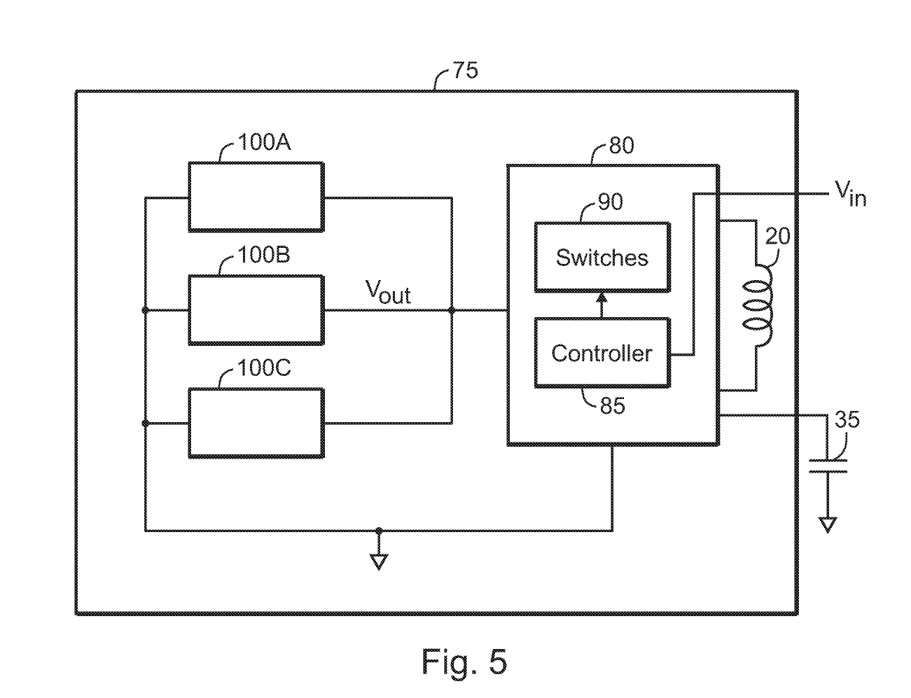

FIG. 5 shows a circuit arrangement for an IC 75 that includes voltage converter 80 according to another exemplary embodiment. IC 75 is similar to the IC depicted in FIG. 4, described above, except that inductor 20 is realized using resources of IC 75, i.e., it resides within IC 75 (e.g., the semiconductor die) or the packaging of IC 75, or both.

More specifically, in some embodiments, inductor 20 may be realized using bondwires, conductor traces, dielectric or permeable materials, or a combination of the foregoing, as desired. In other embodiments, inductor 20 may be realized in other ways, as desired. The choice of implementation of inductor 20 depends on a variety of factors, as persons of ordinary skill in the art will understand. Such factors include design specifications, performance specifications, various figures of merit of inductor 20 (e.g., quality factor, or Q, current-handling capability, value of inductance), cost, IC or device area, available technology, such as semiconductor fabrication technology), target markets, target end-users, etc.

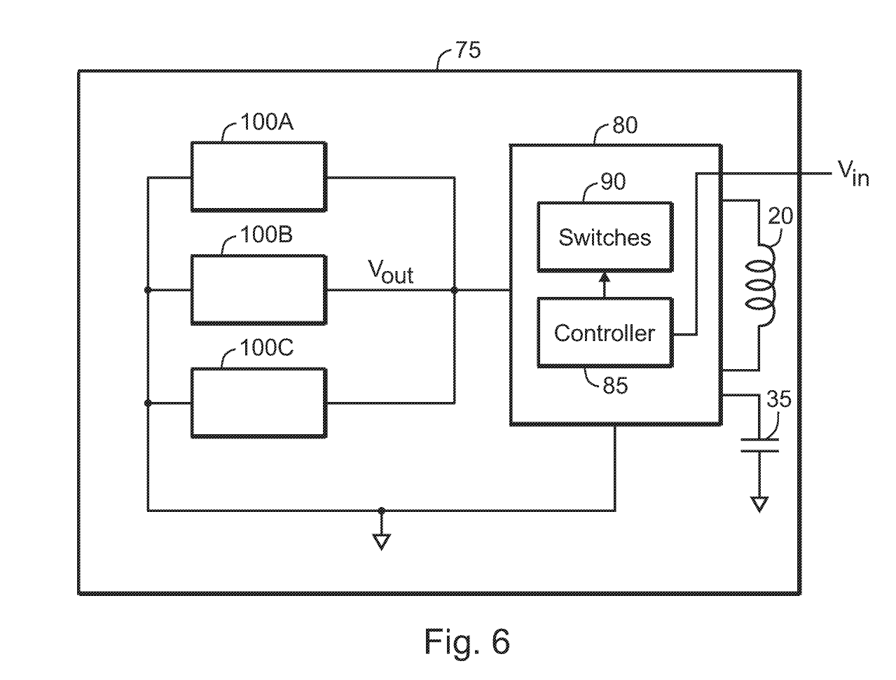

FIG. 6 shows a circuit arrangement for an IC 75 that includes voltage converter 80 according to another exemplary embodiment. IC 75 is similar to the IC depicted in FIG. 4, described above, except that inductor 20 and capacitor 35 are realized using resources of IC 75, i.e., they reside within IC 75 (e.g., the semiconductor die) or the packaging of IC 75, or both.

More specifically, in some embodiments, inductor 20 and capacitor 35 (if used) may be realized using bondwires, conductor traces, metal or other conductor planes, dielectric or permeable materials, or a combination of the foregoing. In other embodiments, inductor 20 and capacitor 35 may be realized in other ways, as desired. The choice of implementation of inductor 20 and capacitor 35 depends on a variety of factors, as persons of ordinary skill in the art will understand. Such factors include design specifications, performance specifications, various figures of merit of inductor 20 (e.g., Q, current-handling capability, value of inductance), various figures of merit of capacitor 35 (e.g., Q, voltage-handling capability, value of capacitance), cost, IC or device area, available technology, such as semiconductor fabrication technology), target markets, target end-users, etc.

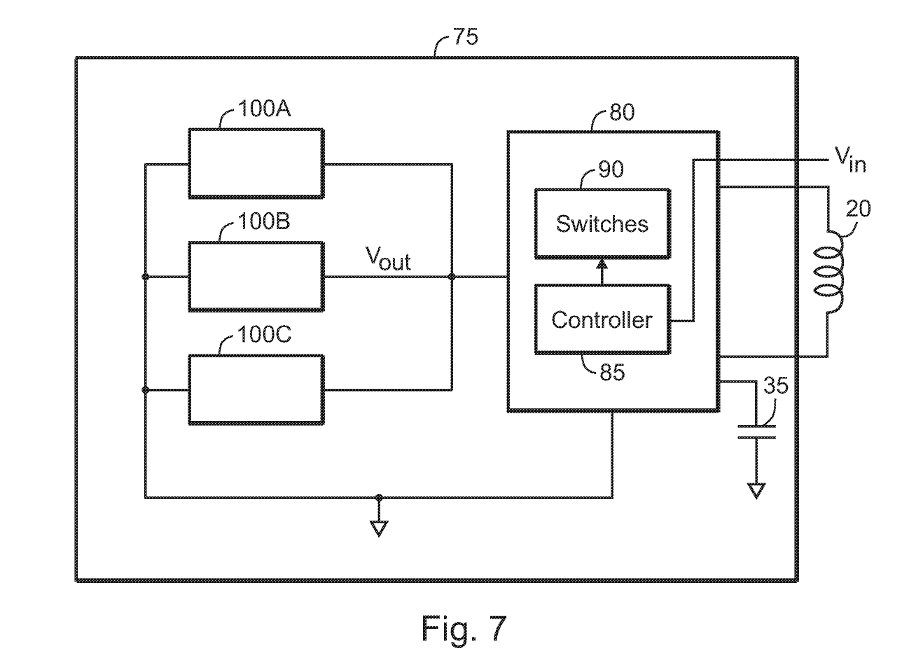

FIG. 7 shows a circuit arrangement for an IC 75 that includes voltage converter 80 according to another exemplary embodiment. IC 75 is similar to the IC depicted in FIG. 4, described above, except that capacitor 35 is realized using resources of IC 75, i.e., it resides within IC 75 (e.g., the semiconductor die) or the packaging of IC 75, or both.

More specifically, in some embodiments, capacitor 35 (if used) may be realized using conductor traces, metal or other conductor planes, dielectric or permeable materials, or a combination of the foregoing. In other embodiments, capacitor 35 may be realized in other ways, as desired. The choice of implementation of capacitor 35 depends on a variety of factors, as persons of ordinary skill in the art will understand. Such factors include design specifications, performance specifications, various figures of merit of capacitor 35 (e.g., Q, voltage-handling capability, value of capacitance), cost, IC or device area, available technology, such as semiconductor fabrication technology), target markets, target end-users, etc.

Referring to FIGS. 4-7, in some embodiments, one or more of loads 100A-100C may be external to IC 75. In some embodiments, controller 85 resides within IC 75 and, in cooperation with switches 90, inductor 20, and capacitor 35, some of which may be external to IC 75, provides an output voltage to one or more loads external to IC 75. In some embodiments, a controller IC may be used, i.e., controller 85 resides within IC 75, but switches 90, inductor 20, capacitor 35, and loads 100A-100C are external to IC 75.

One aspect of the disclosure relates to the implementation of controller 85. Generally speaking, a variety of ways of implementing controller 85 are possible and are contemplated, as persons of ordinary skill in the art will understand. Without limitation, FIGS. 8-14 provide some examples, however, as persons of ordinary skill in the art will understand, other ways of controlling voltage converter 80 to implement the three switching phases are possible and are contemplated.

In some embodiments, a circuit using analog components may be used to control the timing of the various switching phases, such as the second switching phase. FIG. 8 shows a circuit arrangement for controlling the timing of the second switching phase according to an exemplary embodiment that uses analog circuitry.

Initially capacitor 154 (labeled as C1) is charged with a current I₁ supplied from current source 150, over a period of time, T_{ON} (denoted as time period 160). Charging capacitor 154 generates a ramp voltage (shown as waveform 164), of Vᵣₐₘₚ₁=I₁·T_{ON}/C1. After the time period T_{ON}, C1 stops charging and its terminal voltage value is held for later comparison. Capacitor 156 (labeled as C2) then starts charging via current I₂, supplied by current source 152, over a period of time, T_{NTM} (denoted as time period 162), which generates a voltage across capacitor 156 (shown as waveform 166).

The voltages across capacitors 154 and 156 drive the non-inverting and inverting inputs of comparator 158, respectively. Capacitor 156 continues charging until the ramp voltage across it, Vᵣₐₘₚ₂, equals Vᵣₐₘₚ₁, at which point and the output of comparator 158 trips or changes state. At that point, Vᵣₐₘₚ₂=I₂·T_{NTM}/C2. Thus, overall, T_{NTM}=T_{ON}·C1·I₂/(C2·I₁), where C1 and C2 represent the capacitance values of capacitor 154 and capacitor 156, respectively.

By selecting or using a desired ratio I₂/I₁ and/or C1/C2, the ratio T_{NTM}/T_{ON} may be set or programmed or configured to a desired value. In the example shown, current source 152 is a variable current source, which allows setting the ratio T_{NTM}/T_{ON}. By using the time period T_{NTM} as the duration of the second switching phase and the time period T_{ON} as the duration of the first switching phase, the duration of the second switching phase can be made dependent on the duration of the first switching phase (i.e., the two switching-phase durations are related). The output of comparator 158, labeled “End,” is a signal that can be used to indicate the end of the second switching phase and, hence, along with the duration T_{ON}, may be used to control the switches in voltage converter 80, as described above.

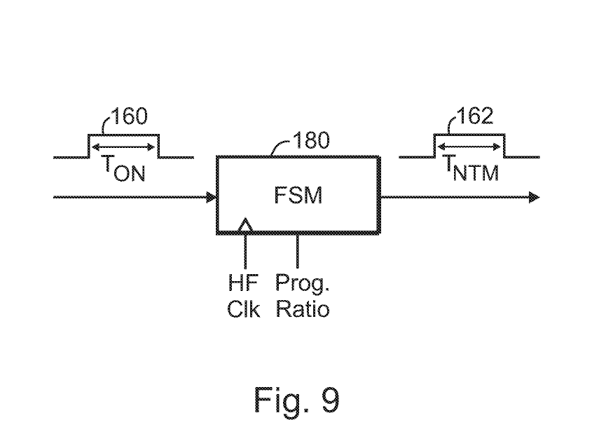

In some embodiments, a circuit using digital components may be used to control the timing of the various switching phases, such as the second switching phase. FIG. 9 shows a circuit arrangement including a controller for a voltage converter according to another exemplary embodiment that uses digital circuitry.

The circuit arrangement in FIG. 9 uses a finite-state machine (FSM) 180, although other implementations may be used, as desired. During T_{ON}, a relatively high-frequency digital clock signal (denoted as “HF Clk”) running at frequency f_{osc} is enabled, and drives a counter in FSM 180 while the signal is high (has a logic high value). At the end of the time period T_{ON}, a digital value corresponding to the counter's terminal count is stored, which is roughly equal to D1=T_{ON}·f_{osc}.

At that time, a second signal goes high (to indicate the end of the count corresponding to T_{ON}) in FSM 180, and another counter in FSM 180 begins to run. A digital comparator in FSM 180 is used to determine when the second count value is equal to the first, i.e., D2=T_{NTM}·f_{osc}, as which point the end of the time period T_{NTM} is reached. As noted above, the time period T_{NTM} and the time period T_{ON} may be used as the duration of the second and first switching phases, respectively.

In general, other values of T_{NTM} than T_{NTM}=T_{ON} might be desired, for instance, T_{NTM} might be a fraction of T_{ON}. FSM 180 receives a value (labeled “Prog. Ratio”) to provide programmable or configurable ratios between T_{NTM} and T_{ON}. The programmable ratio may be implemented in a number of ways, as persons of ordinary skill in the art will understand, such as directly adding a digital offset to one of the counter values, or by dividing one or both of the counter frequencies digitally, as desired.

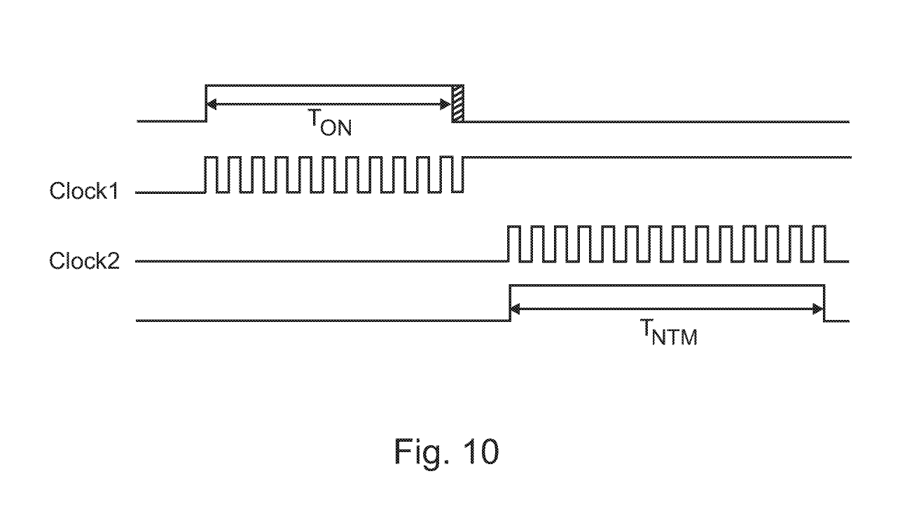

FIG. 10 shows waveforms associated with the operation of the circuit in FIG. 9. The signals “Clock 1” and “Clock 2” represent the clock signals of the two corresponding counters described above.

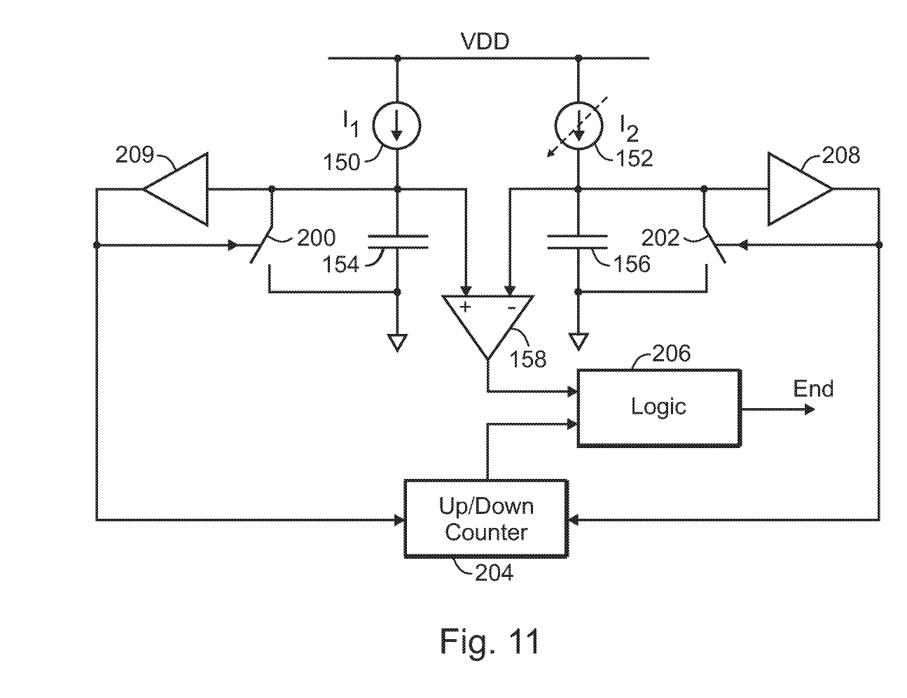

In some embodiments, a mixed-signal circuit (using both digital and analog components) may be used to control the timing of the various switching phases, such as the second switching phase. FIG. 11 shows a circuit arrangement including a controller for a voltage converter according to another exemplary embodiment that uses mixed-signal circuitry.

Similar to the analog implementation of FIG. 8, in the circuit in FIG. 11, initially capacitor 154 (C1) is charged via current I₁, which generates a ramp voltage Vᵣₐₘₚ₁. When Vᵣₐₘₚ₁ exceeds a threshold voltage Vₜ, the voltage across capacitor 154 is reset to zero by closing switch 200, counter 204 counts up, and capacitor 154 begins charging again. This process continues until the time period T_{ON} concludes (duration T_{ON} has been reached).

At that time, capacitor 154 stops charging, and its terminal voltage value is held. Capacitor 156 begins charging via current I₂, generating a voltage Vᵣₐₘₚ₂. When the voltage Vᵣₐₘₚ₂ exceeds a threshold Vₜ, the voltage across capacitor 156 is reset via switch 202, and counter 204 counts down. When the counter value generated by counter 204 reaches zero, the output of comparator 158 is observed and the switching phase ends when the output of comparator 158 trips. Logic circuit 206 uses the output of comparator 158 and the count value of counter 204 to generate the “End” signal, described above. By selecting or using a desired ratio I₂/I₁ and/or C1/C2, the ratio T_{NTM}/T_{ON} may be set or programmed or configured to a desired value. In the example shown, current source 152 is a variable current source, which allows setting the ratio T_{NTM}/T_{ON}.

Switch 200 and switch 202, controlled by threshold-and-delay circuits 209 and 208, respectively, reset the voltages across capacitors 154 and 156, respectively. Threshold-and-delay circuits 209 and 208 detect when the threshold voltage Vₜ, described above, is reached, and control switches 200 and 202, respectively.

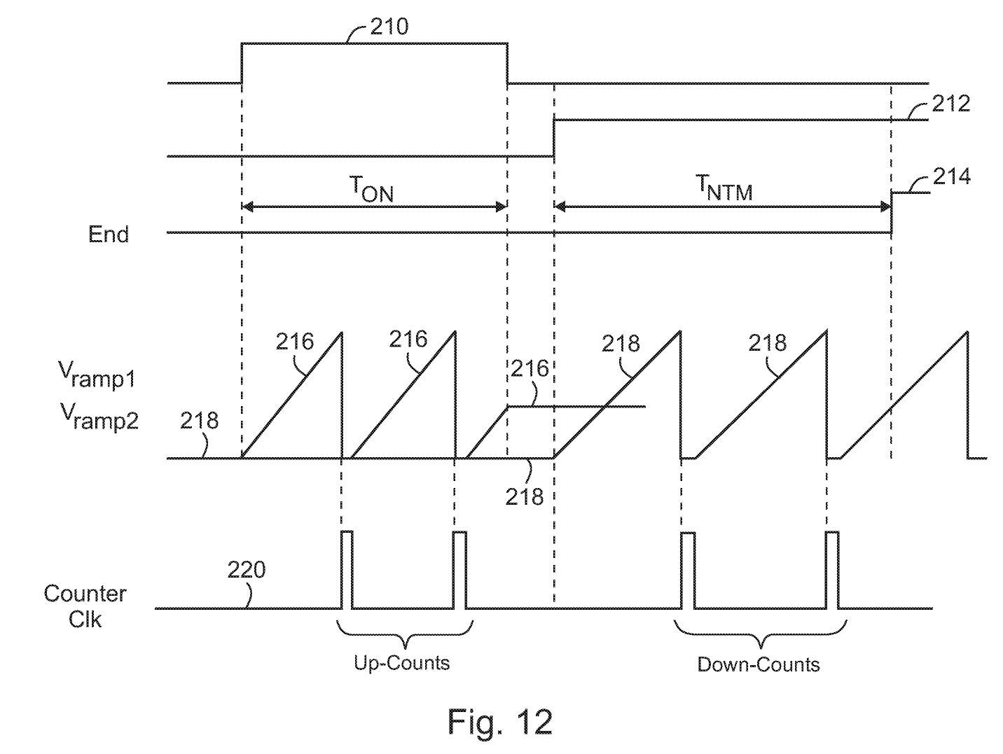

FIG. 12 shows waveforms associated with the operation of the circuit in FIG. 11. More specifically, waveform 210 denotes the drive signal for switch M1, and waveform 212 denotes the drive signal for switch M3 (i.e., in the example shown, logic high values of waveforms 210 and 212 signify the corresponding switch to be in the on state, and vice-versa). Waveform 214 denotes the “End” signal, whereas waveforms 216 and 216 denote voltages Vᵣₐₘₚ₁ and Vᵣₐₘₚ₂, respectively. Waveform 220 denotes the counter signal used to clock counter 204 (see FIG. 11). The up-count and down-count periods and their respective relationships to the T_{ON} and T_{NTM} periods are indicated in FIG. 12.

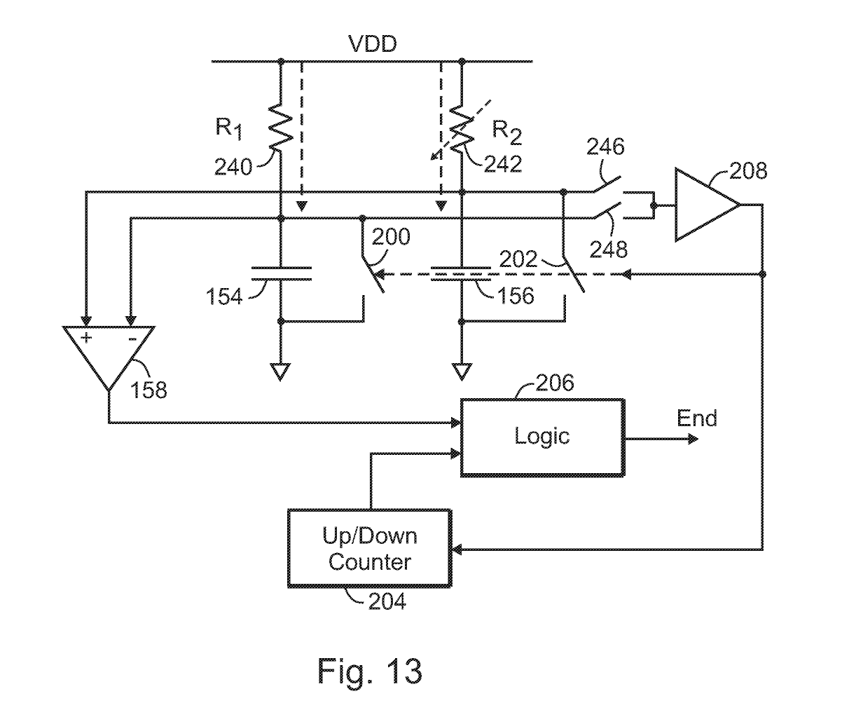

FIG. 13 shows a circuit arrangement including a controller for a voltage converter according to another exemplary embodiment that uses mixed-signal circuitry. Generally, the circuit in FIG. 13 uses components similar to the circuit in FIG. 11. The circuit in FIG. 13, however, includes several modifications compared to the circuit in FIG. 11. First, instead of current sources, the circuit in FIG. 13 implements the charging of capacitors 154 and 156 using resistors 240 (R1) and 242 (R2), respectively. The use of resistors 240 and 242 helps to reduce the startup delay that might result in some error when using current sources.

Additionally, the circuit in FIG. 13 uses a common threshold-and-delay circuit 208, which prevents additional errors that might result from mismatched voltage threshold values. Threshold-and-delay circuit is coupled to capacitor 154 and capacitor 156 using switches 248 and 246, respectively. The threshold is set low enough that charging capacitors 154 and 156 via resistors 240 and 242, respectively, generates nearly linear capacitor charging voltages (Vᵣₐₘₚ₁ and Vᵣₐₘₚ₂, respectively). The ratio T_{NTM}/T_{ON} may be programmed or configured or set by setting the resistor ratio R2/R1. In the embodiment shown, resistor 242 (R2) is a variable resistor, which allows setting the ratio T_{NTM}/T_{ON}.

Referring to FIGS. 8, 11, and 13, each of the circuits illustrated in the figures includes circuitry (not shown) to facilitate proper charging of capacitor 154 and capacitor 156. More specifically, the circuits include mechanisms (such as one or more switches) so as to stop charging capacitor 154 at the end of the T_{ON} period, and to stop charging capacitor 156 at the end of the T_{NTM} period, respectively. Thus, capacitor 154 and capacitor 156 are not charged beyond the T_{ON} and T_{NTM} periods, respectively, and their voltages at the ends of the respective periods are used by comparator 158, as described above.

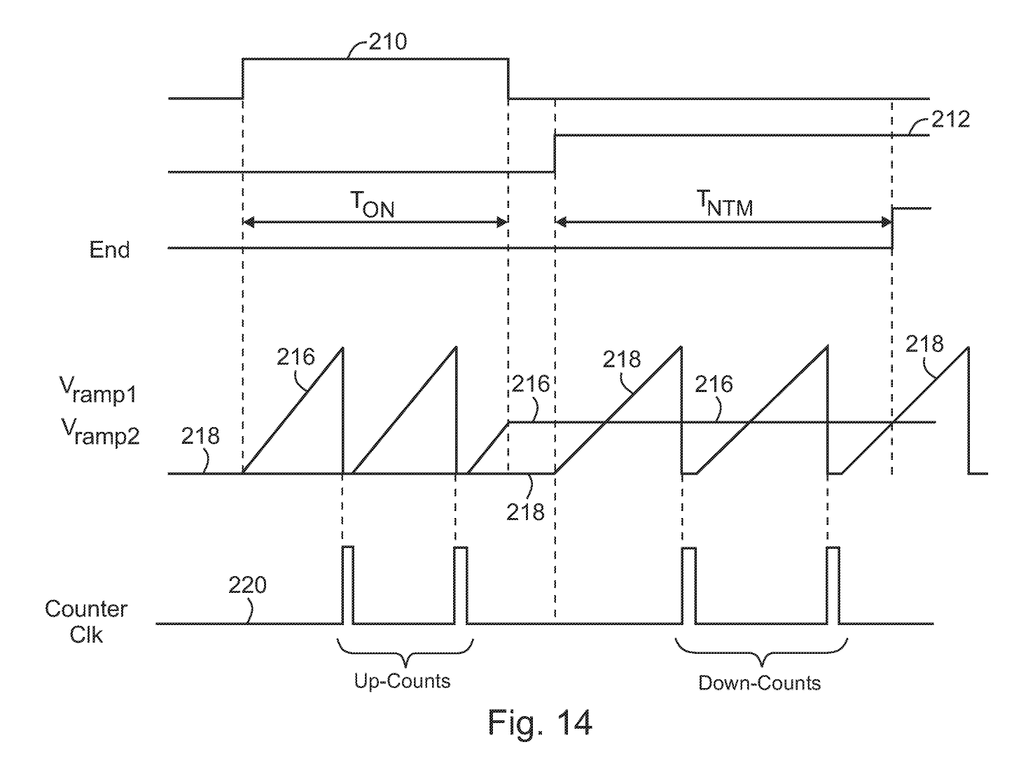

FIG. 14 shows waveforms associated with the operation of the circuit in FIG. 13. Similar to FIG. 12, described above, waveform 210 in FIG. 14 denotes the drive signal for switch M1, and waveform 212 denotes the drive signal for switch M3 (i.e., in the example shown, logic high values of waveforms 210 and 212 signify the corresponding switch to be in the on state, and vice-versa). Waveform 214 denotes the “End” signal, whereas waveforms 216 and 216 denote voltages Vᵣₐₘₚ₁ and Vᵣₐₘₚ₂, respectively. Waveform 220 denotes the counter signal used to clock counter 204 (see FIG. 13). The up-count and down-count periods and their respective relationships to the T_{ON} and T_{NTM} periods are indicated in FIG. 13.

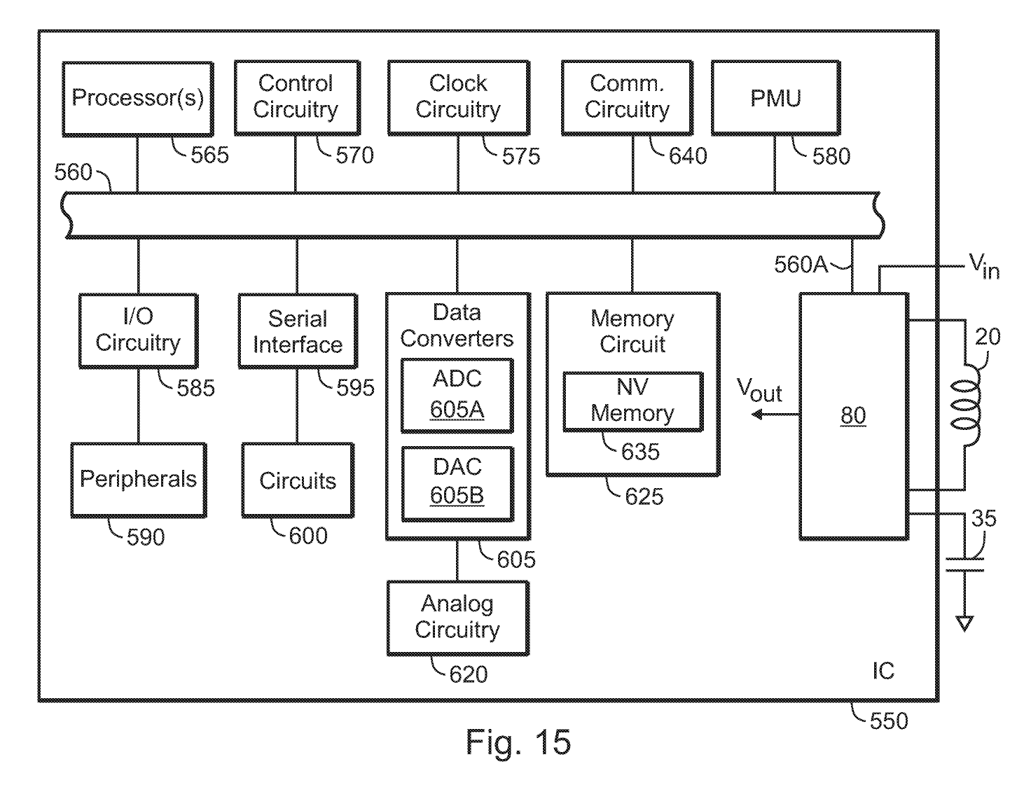

As noted, DC-DC switch-mode converters according to various embodiments may be used in a variety of circuits, blocks, subsystems, and/or systems. For example, in some embodiments, one or more DC-DC switch-mode converters may be integrated in an MCU. FIG. 15 shows a circuit arrangement for such an exemplary embodiment.

MCU 550 includes one or more DC-DC switch-mode converters 80 (as described above). DC-DC switch-mode converter(s) 80 provides power to one or more blocks or circuits or subsystems in MCU 550. In some embodiments, DC-DC switch-mode converter(s) 80 may instead or in addition provide power to one or more circuits, systems, blocks, subsystems, etc., that are external to MCU 550, for instance, by using one or more package pins or pads of MCU 550.

MCU 550 includes a number of blocks (e.g., processor(s) 565, data converter 605, I/O circuitry 585, etc.) that communicate with one another using a link 560. In exemplary embodiments, link 560 may constitute a coupling mechanism, such as a bus, a set of conductors or semiconductor elements (e.g., traces, devices, etc.) for communicating information, such as data, commands, status information, and the like.

MCU 550 may include link 560 coupled to one or more processors 565, clock circuitry 575, and power management circuitry or power management unit (PMU) 580. In some embodiments, processor(s) 565 may include circuitry or blocks for providing information processing (or data processing or computing) functions, such as central-processing units (CPUs), arithmetic-logic units (ALUs), and the like. In some embodiments, in addition, or as an alternative, processor(s) 565 may include one or more DSPs. The DSPs may provide a variety of signal processing functions, such as arithmetic functions, filtering, delay blocks, and the like, as desired.

Clock circuitry 575 may generate one or more clock signals that facilitate or control the timing of operations of one or more blocks in MCU 550. Clock circuitry 575 may also control the timing of operations that use link 560, as desired. In some embodiments, clock circuitry 575 may provide one or more clock signals via link 560 to other blocks in MCU 550.

In some embodiments, PMU 580 may reduce an apparatus's (e.g., MCU 550) clock speed, turn off the clock, reduce power, turn off power, disable (or power down or place in a lower power consumption or sleep or inactive or idle state), enable (or power up or place in a higher power consumption or normal or active state) or any combination of the foregoing with respect to part of a circuit or all components of a circuit, such as one or more blocks in MCU 550. Further, PMU 580 may turn on a clock, increase a clock rate, turn on power, increase power, or any combination of the foregoing in response to a transition from an inactive state to an active state (including, without limitation, when processor(s) 565 make a transition from a low-power or idle or sleep state to a normal operating state).

In addition, in some embodiments, PMU 580 may include control functionality and/or circuitry to control converter 80. In some embodiments, PMU 580 may include some of the control functionality and/or circuitry used to control converter 80. In some embodiments, converter 80 may include control functionality and/or circuitry to control converter 80. Similar considerations apply to control circuitry 570 (e.g., control circuitry 570 may include some or all of the control functionality and/or circuitry to control converter 80, etc.). In some embodiments, one or more blocks or circuits in MCU 550, such as ADC 605A and DAC 605B, may be used as part of controller 85 (not shown explicitly) to control converter 80, for example, when an implementation of controller 85 as shown in FIG. 8 is used.

Referring again to FIG. 15, link 560 may couple to one or more circuits 600 through serial interface 595. Through serial interface 595, one or more circuits or blocks coupled to link 560 may communicate with circuits 600, which may reside outside IC 550. Circuits 600 may communicate using one or more serial protocols, e.g., SMBUS, I²C, SPI, and the like, as person of ordinary skill in the art will understand.

Link 560 may couple to one or more peripherals 590 through I/O circuitry 585. Through I/O circuitry 585, one or more peripherals 590 may couple to link 560 and may therefore communicate with one or more blocks coupled to link 560, e.g., processor(s) 565, memory circuit 625, etc.

In exemplary embodiments, peripherals 590 may include a variety of circuitry, blocks, and the like. Examples include I/O devices (keypads, keyboards, speakers, display devices, storage devices, timers, sensors, etc.). Note that in some embodiments, some peripherals 590 may be external to MCU 550. Examples include keypads, speakers, and the like.

In some embodiments, with respect to some peripherals, I/O circuitry 585 may be bypassed. In such embodiments, some peripherals 590 may couple to and communicate with link 560 without using I/O circuitry 585. In some embodiments, such peripherals may be external to MCU 550, as described above.

Link 560 may couple to analog circuitry 620 via data converter(s) 605. Data converter(s) 605 may include one or more ADCs 605A and/or one or more DACs 605B.

ADC(s) 605A receive analog signal(s) from analog circuitry 620, and convert the analog signal(s) to a digital format, which they communicate to one or more blocks coupled to link 560. Conversely, DAC(s) 605B receive digital signal(s) from one or more blocks coupled to link 560, and convert the digital signal(s) to analog format, which they communicate to analog circuitry 620.

Analog circuitry 620 may include a wide variety of circuitry that provides and/or receives analog signals. Examples include sensors, transducers, and the like, as person of ordinary skill in the art will understand. In some embodiments, analog circuitry 620 may communicate with circuitry external to MCU 550 to form more complex systems, sub-systems, control blocks or systems, feedback systems, and information processing blocks, as desired.

Control circuitry 570 couples to link 560. Thus, control circuitry 570 may communicate with and/or control the operation of various blocks coupled to link 560 by providing control information or signals. In some embodiments, control circuitry 570 also receives status information or signals from various blocks coupled to link 560. In addition, in some embodiments, control circuitry 570 facilitates (or controls or supervises) communication or cooperation between various blocks coupled to link 560.

In some embodiments, control circuitry 570 may initiate or respond to a reset operation or signal. The reset operation may cause a reset of one or more blocks coupled to link 560, of MCU 550, etc., as person of ordinary skill in the art will understand. For example, control circuitry 570 may cause PMU 580, and circuitry such as DC-DC switch-mode converter(s) 80, to assume a known state (e.g., providing one or more voltages having desired values).

In exemplary embodiments, control circuitry 570 may include a variety of types and blocks of circuitry. In some embodiments, control circuitry 570 may include logic circuitry, finite-state machines (FSMs), or other circuitry to perform operations such as the operations described above.

Communication circuitry 640 couples to link 560 and also to circuitry or blocks (not shown) external to MCU 550. Through communication circuitry 640, various blocks coupled to link 560 (or MCU 550, generally) can communicate with the external circuitry or blocks (not shown) via one or more communication protocols. Examples of communications include USB, Ethernet, and the like. In exemplary embodiments, other communication protocols may be used, depending on factors such as design or performance specifications for a given application, as person of ordinary skill in the art will understand.

As noted, memory circuit 625 couples to link 560. Consequently, memory circuit 625 may communicate with one or more blocks coupled to link 560, such as processor(s) 565, control circuitry 570, I/O circuitry 585, etc.

Memory circuit 625 provides storage for various information or data in MCU 550, such as operands, flags, data, instructions, and the like, as persons of ordinary skill in the art will understand. Memory circuit 625 may support various protocols, such as double data rate (DDR), DDR2, DDR3, DDR4, and the like, as desired.

In some embodiments, memory read and/or write operations by memory circuit 625 involve the use of one or more blocks in MCU 550, such as processor(s) 565. A direct memory access (DMA) arrangement (not shown) allows increased performance of memory operations in some situations. More specifically, DMA (not shown) provides a mechanism for performing memory read and write operations directly between the source or destination of the data and memory circuit 625, rather than through blocks such as processor(s) 565.

Memory circuit 625 may include a variety of memory circuits or blocks. In the embodiment shown, memory circuit 625 includes non-volatile (NV) memory 635. In addition, or instead, memory circuit 625 may include volatile memory (not shown), such as random access memory (RAM). NV memory 635 may be used for storing information related to performance, control, or configuration of one or more blocks in MCU 550. For example, NV memory 635 may store configuration information related to DC-DC switch-mode converter(s) 80.

Note that in the exemplary embodiment shown, inductor 20 and capacitor 35 (if used) are external to MCU 550 (similar to the arrangement shown in FIG. 4). Other embodiments are possible and are contemplated, as persons of ordinary skill in the art will understand. Examples include MCUs where one or both of inductor 20 and capacitor 35 are realized using resources of MCU 550, as described above in connection with FIGS. 5-7.

Various circuits and blocks described above and used in exemplary embodiments may be implemented in a variety of ways and using a variety of circuit elements or blocks. For example, various switches (40, 45, 48, and 51), controller 85, current source 150, current source 152, comparator 158, FSM 180, threshold-and-delay circuit 208, threshold-and-delay circuit 209, counter 204, and logic circuit 206 may generally be implemented using digital circuitry, analog circuitry, or mixed-signal circuitry (a mix of digital and analog circuitry). The digital circuitry may include circuit elements or blocks such as gates, digital multiplexers (MUXs), latches, flip-flops, registers, FSMs, processors, programmable logic (e.g., field programmable gate arrays (FPGAs) or other types of programmable logic), arithmetic-logic units (ALUs), standard cells, custom cells, etc., as desired, and as persons of ordinary skill in the art will understand. In addition, analog circuitry or mixed-signal circuitry or both may be included, for instance, power converters, discrete devices (transistors, capacitors, resistors, inductors, diodes, etc.), and the like, as desired. The analog circuitry may include bias circuits, decoupling circuits, coupling circuits, supply circuits, current mirrors, current and/or voltage sources, filters, amplifiers, converters, signal processing circuits (e.g., multipliers), detectors, transducers, discrete components (transistors, diodes, resistors, capacitors, inductors), analog MUXs and the like, as desired, and as persons of ordinary skill in the art will understand. The choice of circuitry for a given implementation depends on a variety of factors, as persons of ordinary skill in the art will understand. Such factors include design specifications, performance specifications, cost, IC or device area, available technology, such as semiconductor fabrication technology), target markets, target end-users, etc.

Referring to the figures, persons of ordinary skill in the art will note that the various blocks shown might depict mainly the conceptual functions and signal flow. The actual circuit implementation might or might not contain separately identifiable hardware for the various functional blocks and might or might not use the particular circuitry shown. For example, one may combine the functionality of various blocks into one circuit block, as desired. Furthermore, one may realize the functionality of a single block in several circuit blocks, as desired. The choice of circuit implementation depends on various factors, such as particular design and performance specifications for a given implementation. Other modifications and alternative embodiments in addition to the embodiments in the disclosure will be apparent to persons of ordinary skill in the art. Accordingly, the disclosure teaches those skilled in the art the manner of carrying out the disclosed concepts according to exemplary embodiments, and is to be construed as illustrative only. Where applicable, the figures might or might not be drawn to scale, as persons of ordinary skill in the art will understand.

The particular forms and embodiments shown and described constitute merely exemplary embodiments. Persons skilled in the art may make various changes in the shape, size and arrangement of parts without departing from the scope of the disclosure. For example, persons skilled in the art may substitute equivalent elements for the elements illustrated and described. Moreover, persons skilled in the art may use certain features of the disclosed concepts independently of the use of other features, without departing from the scope of the disclosure.

1. An apparatus, comprising:
a voltage converter to convert an input voltage to an output voltage, the voltage converter comprising:
a first set of switches operated during a first switching phase; and
a second set of switches operated during a second switching phase, wherein a duration of the second switching phase is related to the duration of the first switching phase.

2. The apparatus according to claim 1, wherein the duration of the second switching phase is a fraction of the duration of the first switching phase.

3. The apparatus according to claim 1, wherein the duration of the second switching phase is related to the duration of the first switching phase by a ratio.

4. The apparatus according to claim 3, wherein the ratio is fixed.

5. The apparatus according to claim 3, wherein the ratio is variable.

6. The apparatus according to claim 1, wherein the voltage converter comprises a buck-boost converter.

7. The apparatus according to claim 1, wherein the duration of the second switching phase is set relative to the duration of the first switching phase in order to trade off an efficiency of the voltage converter with an output-voltage ripple of the voltage converter.

8. The apparatus according to claim 1, further comprising a controller to control the first and second sets of switches during the first and second switching phases, wherein the controller comprises:
a first capacitor charged during a first period of time;
a second capacitor charged during a second period of time; and
a comparator to compare a voltage across the first capacitor with a voltage across the second capacitor.

9. The apparatus according to claim 8, wherein the controller further comprises:
a counter to count up during the first period of time and to count down during the second period of time; and
at least one threshold-and-delay circuit coupled to first and second switches to reset the voltage across the first capacitor and the voltage across the second capacitor, respectively.

10. An integrated circuit (IC), comprising:
a buck-boost voltage converter to convert an input voltage to an output voltage, the buck-boost voltage converter comprising:
an inductor coupled to a set of switches; and
a controller to control a first set of switches in the set of switches for a first period of time, and to control a second set of switches in the set of switches for a second period of time, wherein the second period of time is related to the first period of time by a ratio.

11. The apparatus according to claim 10, wherein the ratio is fixed.

12. The apparatus according to claim 10, wherein the ratio is variable.

13. The apparatus according to claim 12, wherein the ratio is dynamically variable.

14. The apparatus according to claim 10, wherein the IC comprises a microcontroller unit (MCU).

15. A method of operating a voltage converter, the method comprising:
operating a first set of switches in the voltage converter for a first duration; and
operating a second set of switches in the voltage converter for a second duration,
wherein the second duration is derived from the first duration in order to trade off an efficiency of the voltage converter with an output-voltage ripple of the voltage converter.

16. The method according to claim 15, wherein the second duration is a fraction of the first duration.

17. The method according to claim 15, wherein the second duration is related to the first duration by a ratio.

18. The method according to claim 15, wherein the voltage converter comprises a buck-boost converter.

19. The method according to claim 15, further comprising operating a third set of switches in the voltage converter for a third duration.

20. The method according to claim 19, wherein the first, second, and third sets of switches collectively comprise four switches.
